(19) United States
(12) Patent Application Publication
(10) Pub. No.: US 2025/0191379 A1
(43) Pub. Date: Jun. 12, 2025

(54) METHOD FOR DETECTING AND RECOGNIZING A STREET SIGN IN AN ENVIRONMENT OF A MOTOR VEHICLE BY AN ASSISTANCE SYSTEM, COMPUTER PROGRAM PRODUCT, COMPUTER-READABLE STORAGE MEDIUM, AS WELL AS ASSISTANCE SYSTEM

(71) Applicant: CONNAUGHT ELECTRONICS Ltd., Tuam, County Galway (IE)

(72) Inventors: Ahmad Elsallab, Cairo (EG); Senthil Kumar Yogamani, Tuam, County Galway (IE)

(73) Assignee: CONNAUGHT ELECTRONICS Ltd., Tuam, County Galway (IE)

(21) Appl. No.: 18/844,817

(22) PCT Filed: Mar. 2, 2023
(86) PCT No.: PCT/EP2023/055269

§ 371 Date: Sep. 6, 2024

(30) Foreign Application Priority Data
Mar. 8, 2022 (DE) 10 2022 105 413.6

(51) Int. Cl. G06V 20/58; G06V 10/82; G06V 20/62; H04N 23/80

(52) U.S. Cl. CPC G06V 20/582; G06V 10/82; G06V 20/62; H04N 23/815

(57) ABSTRACT

The invention relates to a method for detecting and recognizing (31) a street sign (6) in an environment (5) of a motor vehicle (1) by an assistance system (2) of the motor vehicle (1), comprising the steps capturing at least one image (9) of the environment (5) by an optical capturing device (3) of the assistance system (2), encoding the captured image (9) by a transformer device (12) of an electronic computing device (4) of the assistance system (2), first decoding of the encoded image (9) by a detection transformer device (13) of the electronic computing device (4) for decoding object features (15) in the captured image (9), second decoding of the encoded image (9), wherein the second decoding is performed in parallel to the first decoding, by a recognition transformer device (14) of the electronic computing device (4) for text recognition (16) in the captured image (9) and detection and recognition (31) of the street sign (6) depending on the decoded object features (15) and the text recognition (16) by the electronic computing device (4). Further the invention relates to a computer program product, a computer-readable storage medium, as well as an assistance system (2).

The invention relates to a method for detecting and recognizing a street sign in an environment of a motor vehicle by an assistance system of the motor vehicle. Further, the invention relates to a computer program product, a computer-readable storage medium, as well as an assistance system.

The detection and recognition of street signs is a challenging task for systems of the at least semi-autonomous motor vehicle operation or for systems of fully autonomous motor vehicle operation. This is more difficult than the common detection and recognition of traffic signs and mere symbols. Traffic signs are usually standardized and contain either visual symbols of the sign with a correspondingly small number of text elements or text segments. On the other hand, the street signs are not standardized and may contain a variety of information and shapes. Moreover, the text contained therein is much more comprehensive than in the case of traffic signs and contains a lot of information that is important for higher level systems, such as for instance in the case of parking signs. Often such signs are illuminated. This requires what is referred to as Natural Language Understanding (NLU) to signal the correct information and forward it to for instance higher-level driving functions, such as the automatic parking, in the at least semi-autonomous motor vehicle.

From the prior art it is known that such assistance systems are often based on Optical Character Recognition (OCR) technology. The basis in this connection is formed by the detection and recognition of the street sign and the recognition of the text contained therein. Since there may be more than one street sign in the environment, these systems need to be in a position to detect and identify several objects.

To this end, so-called pipeline approaches are known from the prior art, wherein two separate models are to be considered. To start with, the detection and recognition is effected, then the known parts are correspondingly cut out and forwarded to a recognition model. In this connection often an encoder/decoder architecture is used.

It is an object of the present invention to provide a method, a computer program product, a computer-readable storage medium, as well as an assistance system, by which an improved detection and recognition of street signs in the environment of a motor vehicle can be realized.

This object is solved by a method, a computer program product, a computer-readable storage medium, as well as an assistance system according to the independent patent claims. Advantageous embodiments are indicated in the subclaims.

One aspect of the invention relates to a method for detecting and recognizing a street sign in an environment of a motor vehicle by an assistance system of the motor vehicle. A capturing of at least one image of the environment by an optical capture device of the assistance system is effected. The image in this connection preferably also comprises at least the street sign that can be discerned. The captured image is encoded by a transformer device of an electronic computing device of the assistance system. A first decoding of the encoded image is effected by a detection transformer device of the electronic computing device for decoding object features in the captured image. The encoded image is further decoded for a second time, wherein the second decoding is performed in parallel to the first decoding, in particular in a parallel evaluation string of the electronic computing device, by a recognition transformer device of the electronic computing device for text recognition in the captured image. The street sign is recognized depending on the decoded object features and the text recognition by the electronic computing device.

In particular thus an improved detection and recognition of street signs in the environment of the motor vehicle is realized. Detecting and recognizing in the present case is to be understood in particular as detecting and recognizing of corresponding contents of the street sign. In particular the street sign is a so-called additional sign in road traffic. In other words, the street sign is not a traffic sign, which for instance merely resorts to symbols with little text. The street sign often comprises a plurality of symbols with a plurality of text or text fragments, respectively. The street sign is in particular not standardized and may also comprise different, non-standardized texts. In order to be able to detect and recognize the street sign and in particular to interpret the content, thus a corresponding evaluation or interpretation of the street sign needs to be performed.

In particular a Multi-Task-Learning (MTL) approach is thus proposed in order to save memory and interference time by using a joint model of decoders for the detection/recognition and the text recognition, in particular Natural Language Understanding parts. The Multi-Task-Learning Transformer Architecture is used for the joint detection and recognition of several street signs. The text recognition therein is treated as a problem of sequence generation, wherein the text recognition in this connection is realized via the generating of a token from the preceding token. The employment of transformer-based models, in combination with for instance neural-network-based models is advantageous in order to be used both in the extraction of spatial features as well as in the encoding of sequential features. In particular a transformer-based text recognition for several texts per scene is proposed by using for instance a bipartite loss based on a similarity of text.

In particular, the invention in this connection makes use of the fact that the recurrent neural networks (RNN such as for instance LSTM-Long-Short Term Memory) in the prior art are replaced by the corresponding transformers. The main advantages of transformers over the Long-Short-Term methods are, on the one hand, that these can process sequential information. In this connection a parallel encoding of inputs, in particular of so-called image slices, by using self-attention mechanisms (full-attention mechanisms) can be employed. Further, an encoding of sequential information by using the so-called Positional Embedding (Position Encoding) can be used. Thereby a fast interference in comparison with sequential processing of RNN models is effected. The proposed architecture or the proposed assistance system, respectively, therein is in particular based on the components of the transformer device for encoding as well as on the decoder devices for detecting and recognizing a plurality of street signs, wherein same for instance comprises a so-called DETR (DEtection TRansformer) Architecture.

DETR is in particular an end-to-end detection based on transformers. The transformer method is a method by which a computer or an electronic computing device, respectively, can translate a sequence of characters into another sequence of characters. Same can for example in particular be used for translating text from one language into another. In particular this method is one of machine learning. In particular, to this end, the transformer is trained by machine learning on an, in particular large, quantity of example data, before the trained model then can be used for translation. Transformers belong to the deep learning architectures. A transformer therein is substantially composed of encoders connected in series and decoders connected in series. The input sequence is transformed by a so-called embedding layer into a vector representation. The weights of the embedding layer are adapted during training. In the case of the transformer additionally a position encoding is employed, whereby the sequential order of the words can be taken into consideration. A word thus is given a different representation at the beginning of a sentence than at the end.

The proposed assistance system or the corresponding method, respectively, in this connection has in particular the advantages that for instance several street signs per scene can be processed. Moreover, the assistance system has a fast processing time compared with the pipeline-based method. The transformer-based methods accelerate the interference in comparison with the sequential processing of recurrent neural network models. Further, by the common encoder of the multi-task-learning memory and interference times can be saved.

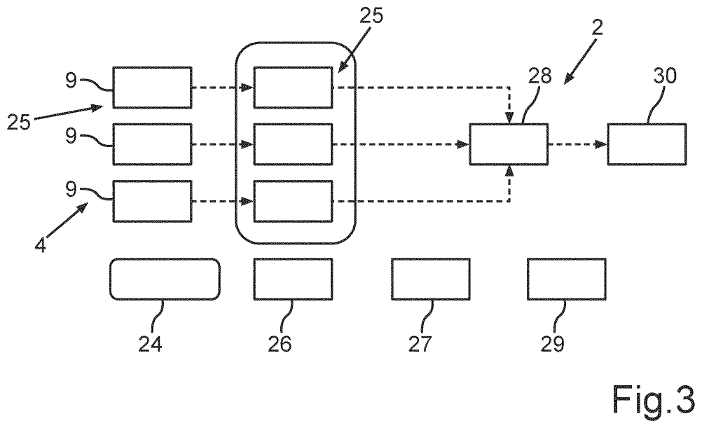

When deploying the proposed method according to FIG. 3 also the input of a video sequence, in particular thus a plurality of consecutive images, is facilitated. In particular in this connection it may occur that for instance also in a video sequence a sign text might be too small to be recognized, although this has been captured at least as text. In particular this may be due to the fact that the text is still far away. It may therefore equally be possible that in the present method the generation of text may be conditioned based on the detected area of the box, which was captured, wherein a certain threshold value is to be observed. Following detection of the proper area with the sign, a simple object tracking algorithm, such as for instance a Kalman filter, may be employed to track the sign.

According to an advantageous embodiment the transformer device is provided as convolutional neural network. In particular the input of the at least one image I_{H×W×C} is effected via the convolutional neural network, which may also be referred to as CNN. The image therein is flattened and reshaped to obtain a twodimensional tensor I_{HW×d}, which represents the feature vector of dimension d for each H×W pixel. Thus a reliable evaluation of the image may be effected.

It is moreover advantageous if the transformer device with a self-attention module is provided. A self-attention module is in particular a self-attention module. In particular the twodimensional tensor of the convolutional neural network is then fed to the self-attention in the transformer encoder. This encoder keeps an attention map W_{HW×HW} containing the attention weights between each pixel and all others. This may for instance also be referred to as so-called self-correlation between the pixels. A scaled dot product of this attention map by the input image results in the vector E_{HW×d}. In self-attention a vector Q=K=V=I_{HW×d} is generated since the objective here is to obtain a correlation between all locations and all other locations, therefore also the term self-attention. The encoded vectors can be calculated as follows:

$${W}_{H W \times H W} = Soft ( Q \times {K}^{T} )$$

$${E}_{H W \times d} = {W}_{H W \times H W} * {I}_{H W \times d}$$

Thus, an improved evaluation of the image with regard to sign detection and recognition may be realized.

In a further advantageous embodiment the detection transformer device with a further self-attention module is provided. Further, it may be envisaged that by the detection transformer device a multiple object detection is performed. In particular thus on the basis of the encoded vector E_{HW×d} a decoder device for decoding the object features may be used. In this connection an attention mechanism equal to that used for the transformer device may be used. This time, however, objects are extracted based on the spatial image features E_{HW×d}. It may be assumed that a maximum of q objects per image can be generated since in particular several object detections are performed. A transformation of the HW image features into q object features, which for instance can also be referred to as object queries, is learned. To achieve this, however, it is not possible to perform the same self-attention as in the encoder. In particular it is envisaged that K=K=V=E_{HW×d} is used, wherein the queries are set to the object queries Q=Q_{q×d}. The transformation will follow the following equations, which results in a decoded vector D_{q×d} that represents q object queries each with d features.

$${W}_{q \times H W} = Soft ( Q \times {K}^{T} )$$

$${D}_{q \times d} = {W}_{q \times H W} * {I}_{H W \times d}$$

Thus a feature extraction in the image can be realized in improved manner.

It is further advantageous if by a Hungarian method and/or bipartite loss method a joining of the object detection and the text recognition is performed by the electronic computing device. In particular the above-presented decoded vector D_{q×d} can be treated as potential object and matched to objects of the ground truth in the image based on the Hungarian Matcher, which corresponds to the Hungarian method, and in particular to what is also referred to as bipartite loss. Accordingly, the entire model can be optimized by gradient-based optimizations, such as for instance the stochastic gradient descent and its corresponding variants. Thus, an improved street sign detection and recognition can be realized.

In particular since there may be for instance multiple signs per image, a so-called matching problem may occur, in which many ground truth texts and many predicted texts may occur. To obtain a loss, these are matched together, to be able to compare them, and a score is obtained that indicates the performance of the model and forms the base to the so-called gradient-based optimization. This may in particular, as has already been mentioned, be solved by the Hungarian method. Thus, this algorithm may be proposed which is based on the ground truth texts and the predicted texts and for example replaces the corresponding minimally surrounding boxes. For the text similarity measure there are many alternatives, for example cosine, dot product, Mahalanobis distance or the like.

It is further advantageous if the recognition transformer device is provided with a yet further self-attention module. Further, the recognition transformer device can also be provided with a vocabulary database. In particular thus the second decoder arm is presented, which is concerned with the text recognition of the signs in the image. Similar to the detection transformer device the input is the encoded vector E_{HW×d}. In particular a text decoder is used to generate a quantity of q queries for each box, each with dimension d. The recognition transformer device has the vector K=V=E_{HW×d}, whilst the queries in this case are a quantity of s output tokens, wherein s represents the generated text length. In this case text queries are generated with Q=Q_{q×d}, which represents a dimensional vector for each potential text box. Similar to the detection transformer device, using attention mechanisms, decoded text predictions D_{q×d} representing a d dimensional vector for q queries are generated. The text prediction D_{q×d} can now be translated into a text token T_{q×s×v}, wherein a sequence of two tokens per text box can be used. Each token can be described as a probability distribution over v possible vocabulary tokens. The vocabulary space or v of the vocabulary database, respectively, differ according to the token type. In particular, a word or sign can be used for this to obtain the final token.

Further it has turned out to be advantageous if the text recognition is performed in a word-based or character-based manner. Moreover, for text recognition a softmax function of the recognition transformer device may be used. In particular the vocabulary space v, which in particular also corresponds to the vocabulary database, can be distinguished according to the token type. For this purpose, this can be effected both in a word-based or a character-based manner, respectively. In order to obtain the final token, in particular the softmax operation is performed over the outputs, wherein a quantity of s output tokens T_{q×s} is obtained. In particular, now mention has been of a so-called token as text token, wherein in this connection a maximum of s outputs per box are realized. The space for each token is referred to as vocabulary, which comprises a maximum of v possible values. Whilst the word-based approach has a larger vocabulary v but also a limited sequence length s. The opposite is the case with the character-based approach. The word-based approach, however, has a further disadvantage, namely the problem of missing vocabulary (Out-Of-Vocabulary, OOV), in which case the new words may remain unseen during the training, whilst this is not the case for characters. In particular for the generation process the token has to follow an autoregressive (AR-Auto Regression) decoding method, that is each output token in addition to the tokens generated so far depends on the encoded spatial vector E_{HW×d}. During training, the tokens of the ground truth can be directly used before the current token, which has the effect of guiding the model in its early training phases. This is also referred to as so-called teacher forcing. During interference or operation, respectively, it is not possible to access the ground truth. In this case the previously generated token is fed back. In both cases, the operation is performed by a so-called masking of the next token after the current position in order to keep the matrix operations the same.

It is further advantageous if on the basis of street sign detection and recognition an updating of an environment map and/or a localization of a motor vehicle relative the environment is performed. In particular it is now proposed that the street signs can also be used for localization. Thus, a rough geotagging can be used, in which the text is output and assigned for example to a nearest landmark. In particular thus the proposed assistance system can be used for localizing the position of the street sign precisely and to use this information, for example, to update an environment map, in particular a so-called high definition map (HD map), with a new landmark. The new landmark may then comprise the detected and recognized street sign and the corresponding text, unless already present in the map.

It is further advantageous if for the street sign detection and recognition a current speed of the motor vehicle is taken into consideration and/or a resolution enhancement of the at least one image is performed. In particular in the case of the text recognition in automotive scenes there are two main challenges. One is blurring of the text due to speeds, in particular high speeds, of the motor vehicle. In particular, thus, it is proposed to estimate the odometry of the motor vehicle and to convert it into a motion-induced flow tensor, which is based on an estimated position of the text patch in the environment. The feature vectors of these text patches are aggregated over time and passed to a parametric deblurring block which is adapted by the motion-induced flow tensor. The weights of the deblurring block are learned in a supervised way. Typically, it is a difficult problem, to provide metrics for the deblurring. In this case the recognition accuracy is used as final metric to optimize the deblurred text block. This block extends the architecture into a spatio-temporal transformer whose backbone features are shared so that previously computed backbone features are reused simply and efficiently without a recomputing being required.

The second problem is related to low resolution of faraway text signs which have to be recognized. The consecutive frames typically capture sub-pixel information as the translation into the world sub-pixel. This provides the opportunity to aggregate information from consecutive frames to improve the resolution of the text, which is also referred to as super resolution. The same spatio-temporal transformer construction can be leveraged with a super-resolution module. This can be implemented as a separate super-resolution block which makes use of the distance from the motor vehicle and inputs scale changes of the text patch into the super-resolution module.

The presented method is in particular a computer-implemented method. Therefore, a further aspect of the invention also relates to a computer program product with program code means, which, when the program code means are executed by an electronic computing device, cause an electronic computing device to perform a corresponding method. Further the invention also relates to a computer-readable storage medium with a computer program. The computer program product may also be referred to as computer program.

Moreover, the invention also relates to an assistance system for a motor vehicle for detecting and recognizing a street sign in an environment of a motor vehicle, comprising at least one optical capturing device and comprising an electronic computing device, wherein the assistance system is configured for performing a method according to the preceding aspect. In particular the method is performed by the assistance system.

The electronic computing device for example comprises electronic components, such as processors, circuits, in particular integrated circuits, as well as further electronic components in order to be able to perform corresponding method steps.

Moreover, the invention also relates to a motor vehicle comprising an assistance system according to the preceding aspect.

The motor vehicle in this connection may be configured to be at least semi-autonomous or fully autonomous.

Advantageous embodiments of the method are to be regarded as advantageous embodiments of the computer program product, the computer-readable storage medium, the assistance system, as well as the motor vehicle. The assistance system and the motor vehicle in particular comprises means for this purpose to be able to perform corresponding method or an advantageous embodiment hereof.

Further features of the invention are apparent from the claims, the figures and the figure description. The features and combinations of features mentioned above in the description as well as the features and combinations of features mentioned below in the description of the figures and/or shown in the figures alone are employable not only in the respective combination stated, but also in other combinations, without departing from the scope of the invention. In particular, thus also embodiments are to be regarded as comprised by the invention, which are not explicitly shown or explained in the figures, however, derive by separated feature combinations from the mentioned explanations and can be generated therefrom. Also implementations and feature combinations are to be regarded as disclosed which thus do not comprise all features of an originally formulated independent claim. Moreover, embodiments and feature combinations are to be regarded as disclosed, in particular by the explanations given in the above, which go beyond or deviate from the feature combinations set out in the back-references of the claims.

In the following, the invention is explained in further detail with reference to the enclosed drawings.

These show in:

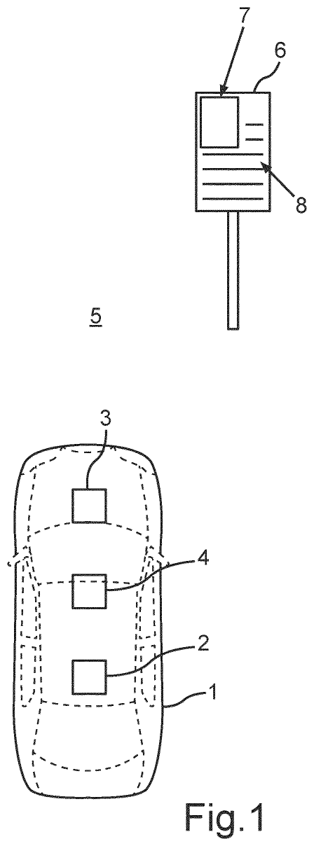

FIG. 1 a schematic top view of an embodiment of a motor vehicle with an embodiment of an assistance system;

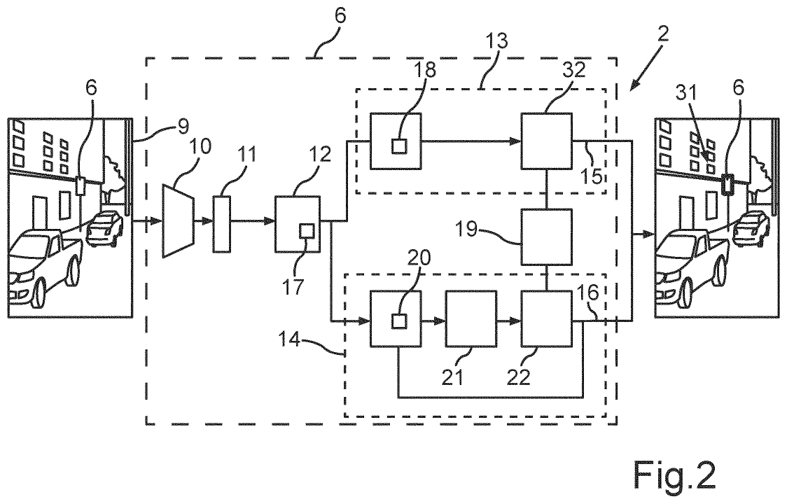

FIG. 2 a schematic block diagram according to an embodiment of the assistance system; and

FIG. 3 a further schematic block diagram according to an embodiment of the assistance system.

In the figures same or functionally identical elements are equipped with the same reference signs.

FIG. 1 shows a schematic top view of an embodiment of a motor vehicle 1 comprising an embodiment of an assistance system 2. The assistance system 2 comprises at least one capturing device 3 as well as an electronic computing device 4. The capturing device 3 is in particular configured as optical capturing device 3, and may preferably be provided in the form of a camera. By the optical capturing device 3 an environment 5 of the motor vehicle 1 can be captured. In particular the motor vehicle 1 is configured to be at least semi-autonomous. The motor vehicle 1 may also be configured to be fully autonomous. By the assistance system 2 then in turn an evaluation of the environment 5 for the at least semi-autonomous operation of the motor vehicle 1 can be performed. In the present embodiment in the environment 5 there is a street sign 6. The street sign 6 for instance comprises a symbol 7 as well as a text 8. In particular the street sign 6 is not a traffic sign. In particular the street sign 6 for instance comprises a plurality of words or characters, respectively, which have a corresponding content. For instance the street sign 6 can be referred to as parking sign, wherein here information relating to the parking are described as well. For instance the street sign 6 may describe corresponding parking times, which are to be noted on working days and which are to be noted on holidays. Thus, a plurality of information is to be noted on the street sign 6. In particular the street sign 6 is a non-standardized street sign 6.

FIG. 2 shows a schematic block diagram according to an embodiment of the assistance system 2. In particular the assistance system 2 is represented for detecting and recognizing the street sign 6 in the environment 5. For this purpose, in particular by the optical capturing device 3 an image 9 of the environment 5 is captured. The image 9 in turn may be passed to a so-called backbone 10. In the present embodiment a projecting and redesigning module 11 may be provided. The assistance system 2 further comprises a transformer device 12, wherein the transformer device 12 is configured for encoding the captured image 9. The electronic computing device 4 further comprises a detection transformer device 13, wherein the detection transformer device 13 is configured for decoding object features in the captured image 9. Further, a recognition transformer device 14 of the electronic computing device 4 is provided, which in particular runs in parallel to the detection transformer device 13, wherein the recognition transformer device 14 is configured for text recognition in the captured image 9. The street sign 6 is then recognized depending on the decoded object feature 15 and the text recognition 16 by the electronic computing device 4.

In particular the transformer device 12 is provided as convolutional neural network. Further, the transformer device 12 comprises at least one self-attention module 17. The detection transformer device 13 comprises a further self-attention module 18. Further, by the detection transformer device 13 a multiple object detection can be performed. In particular for instance a Hungarian method, which in the present case is represented by a so-called matcher 19, and/or a bipartite loss method for the detection and recognition 31 of the street sign 6 can be used.

Moreover, it may be envisaged that the recognition transformer device 14 comprises a yet further self-attention module 20. Moreover the recognition transformer device 14 may comprise a vocabulary database 21 as well as a softmax function 22.

In particular thus an improved detection and recognition 31 of street signs 6 in the environment 5 of the motor vehicle 1 is realized. Detecting and recognizing 31 in the present case is to be understood in particular as the capturing and recognizing 31 of corresponding contents of the street sign 6. In particular the street sign 6 is a so-called additional sign in road traffic. In other words, the street sign 6 does not form a traffic sign, which for instance merely resorts to symbols with little text. The street sign 6 often comprises a plurality of symbols with a plurality of text or text fragments, respectively. The street sign 6 is in particular not standardized and may also comprise different, non-standardized texts. In order to be able to recognize and the street sign 6 and in particular to interpret its content, thus a corresponding evaluation or interpretation of the street sign 6 needs to be effected.

In particular thus a Multi-Task Learning (MTL) approach is proposed in order to save memory and interference time by using a joint model of decoders for the detection/recognition and the text recognition, in particular Natural Language Understanding parts. The Multi-Task Learning Transformer architecture is used for the joint detection and recognition 31 of several street signs 6. In this connection the text recognition 16 is treated as a problem of sequence generation, wherein the text recognition 16 is realized via the generation of a token from the preceding token. Making use of transformer-based models, combined with for example neural-network-based models is advantageous in order to be used both in the extraction of spatial features as well as in the encoding of sequential features. In particular a transformer-based text recognition 16 is proposed for several texts per scene, for instance by using a bipartite loss based on text similarity.

The main advantages of transformers are, on the one hand, that they can process sequential information. In this connection a parallel encoding of inputs, in particular of so-called image slices, using self-attention mechanisms (full-attention mechanisms), can be used. Further, an encoding of sequential information can be used by using the so-called Positional Embedding (Position Encoding). Thereby a fast interference in comparison with sequential processing of RNN models is effected. The proposed architecture or the proposed assistance system 2, respectively, in this connection is based in particular on the components of the transformer device for encoding as well as on the decoder for detecting and recognizing a plurality of street signs 6, wherein same for example has a so-called DETR (DEtection TRansformer) architecture.

DETR is in particular an end-to-end detection based on transformers. The transformer method is a method by which a computer or an electronic computing device 4 can translate a sequence of signs into another sequence of signs. This may for instance in particular be used for translating text from one language into another. In particular this method is a method of machine learning. In particular for this purpose the transformer is trained by machine learning on an, in particular large, quantity of example data, before the trained model then can be used for translation. Transformers belong to the Deep Learning architectures. A transformer in this connection is substantially composed encoders connected in series and decoders connected in series. The input sequence is transformed by a so-called embedding layer into a vector representation. The weights of the embedding layer are adapted during training. In the case of the transformer in addition a position encoding is employed, whereby the sequential order of the words can be taken into consideration. A word thus is given a different representation at the beginning of a sentence than at the end.

The proposed assistance system or the corresponding method, respectively, in this connection has in particular the advantages that for instance several street signs 6 per scene can be processed. Moreover, the assistance system 2 has a fast processing time compared with the pipeline-based method. The transformer-based methods accelerate the interference in comparison with the sequential processing of recurrent neural network models. Further, by the common encoder of the multi-task learning memory and interference time can be saved.

In particular the input of the at least one image I_{H×W×C} is effected via the convolutional neural network, which is may also be referred to as CNN. The image 9 in this connection is flattened and reshaped to obtain a twodimensional tensor I_{HW×d}, which represents the feature vector of dimension d for each H×W pixel.

In particular the twodimensional tensor of the convolutional neural network is then fed to the self-attention in the transformer encoder. This encoder contains an attention map W_{HW×HW} containing the attention weights between each pixel and all others. This may for instance also be referred to as so-called self-correlation between the pixels.

A scaled dot product of this attention map by the input image, in particular the image 9, results in the vector E_{HW×d}. In self-attention a vector Q=K=V=I_{HW×d} is generated since the objective here is to obtain a correlation between all locations and all other locations, therefore also the term self-attention. The encoded vectors can be calculated as follows:

$${W}_{H W \times H W} = Soft ( Q \times {K}^{T} )$$

$${E}_{H W \times d} = {W}_{H W \times H W} * {I}_{H W \times d}$$

In particular thus on the basis of the encoded vector E_{HW×d} a decoder device for decoding the object features 15 may be used. In this connection an attention mechanism equal to that used for the transformer device 12 may be used. This time, however, objects are extracted based on the spatial image features E_{HW×d}. It may be assumed that a maximum of q objects per image 9 can be generated since in particular several object detections are performed. A transformation of the HW image features into q object features, which for instance can also be referred to as object queries, is learned. To achieve this, however, it is not possible to perform the same self-attention as in the encoder. In particular it is envisaged that K=K=V=E_{HW×d} is used, wherein the queries are set to the object queries Q=Q_{q×d}. The transformation will follow the following equations, which results in a decoded vector D_{q×d} that represents q object queries each with d features.

$${W}_{q \times H W} = Soft ( Q \times {K}^{T} )$$

$${D}_{q \times d} = {W}_{q \times H W} * {I}_{H W \times d}$$

In particular the above-presented decoded vector D_{q×d} can be treated as potential object and matched to objects of the ground truth in the image 9 based on the Hungarian Matcher 19, which corresponds to the Hungarian method, and in particular to what is also referred to as bipartite loss. Accordingly, the complete model can be optimized by gradient-based optimizations, such as for instance the stochastic gradient descent and its corresponding variants.

In particular since there may be for instance multiple signs per image 9, a so-called matching problem may occur, in which many ground truth texts and many predicted texts may occur. To obtain a loss, these are matched together, to be able to compare them, and a score is obtained that indicates the performance of the model and the base to the so-called gradient-based optimization. This may in particular, as has already been mentioned, be solved by the Hungarian method. Thus, this algorithm may be proposed which is based on the ground truth texts and the predicted texts and for example replaces the corresponding minimally bounding boxes. For the text similarity measure there are many alternatives, for example cosine, dot product, Mahalanobis distance or the like.

The second decoding arm is concerned with the text recognition 16 of the signs in the image 9. Similar to the detection transformer device 13 the input is the encoded vector E_{HW×d}. In particular a text decoder is used to generate a quantity of q queries for each box, each with dimension d. The recognition transformer device 14 has the vector K=V=E_{HW×d}, whilst the queries in this case are a quantity of s output tokens, wherein s represents the generated text length. In this case text queries are generated with Q=Q_{q×d}, which represents a dimensional vector for each potential text box. Similar to the detection transformer device 13, using attention mechanisms, decoded text predictions D_{q×d} representing a d dimensional vector for q queries are generated. The text prediction D_{q×d} can now be translated into a text token T_{q×s×v}, wherein a sequence of two tokens per text box can be used. Each token can be described as a probability distribution over v possible vocabulary tokens. The vocabulary space or v or the vocabulary database 21, respectively, differ according to the token type. In particular, a word or sign can be used for this to obtain the final token.

In particular the vocabulary space v, which in particular also corresponds to the vocabulary database 21, can be distinguished according to the token type. For this purpose, this can be effected both in a word-based and a character-based manner, respectively. In order to obtain the final token, in particular the softmax operation or the softmax function 22, respectively, is performed over the outputs, wherein a quantity of s output tokens T_{q×s} is obtained. In particular, now mention has been of a so-called token as text token, wherein in this connection a maximum of s outputs per box are realized. The space for each token is referred to as vocabulary, which comprises a maximum of v possible values. Whilst the word-based approach has a larger vocabulary v but also a limited sequence length s. The opposite is the case with the character-based approach. The word-based approach, however, has a further disadvantage, namely the problem of missing vocabulary (Out-Of-Vocabulary, OOV), in which case the new words may remain unseen during the training, whilst this is not the case for characters. In particular for the generation process the token has to follow an autoregressive (AR—Auto Regression) decoding method, that is each output token in addition to the tokens generated so far depends on the encoded spatial vector E_{HW×d}. The auto regression in the present case is in particular represented as backward arrow 32. During training, the tokens of the ground truth can be directly used before the current token, which has the effect of guiding the model in its early training phases. This is also referred to as so-called teacher forcing. During interference or operation, respectively, it is not possible to access the ground truth. In this case the previously generated token is fed back. In both cases, the operation is performed by a so-called masking of the next token after the current position in order to keep the matrix operations the same.

In particular it is further proposed that the street signs 6 can also be used for localization. Thus, a rough geotagging can be used, in which the text is output and assigned for example to a nearest landmark. In particular, thus, the proposed assistance system 2 can be used for localizing the position of the street sign 6 precisely and to use this information, for example, to update an environment map, in particular a so-called high definition map (HD map), with a new landmark. The new landmark may then comprise the detected and recognized street sign 6 and the corresponding text, unless already present in the map.

In particular in the case of the text recognition 16 in automotive scenes there are two main challenges. One is blurring of the text due to speeds, in particular high speeds, of the motor vehicle 1. In particular, thus, it is proposed to estimate the odometry of the motor vehicle 1 and to convert it into a motion-induced flow tensor, which is based on an estimated position of the text patch in the environment 5. The feature vectors of these text patches are aggregated over time and passed to a parametric deblurring block which is adapted by the motion-induced flow tensor. The weights of the deblurring block are learned in a supervised way. Typically, it is a difficult problem, to provide metrics for the deblurring. In this case the recognition accuracy is used as final metric to optimize the deblurred text block. This block will extend the architecture into a spatio-temporal transformer whose backbone features are shared so that previously computed backbone features are reused simply and efficiently without a recomputing being required.

The second problem is related to low resolution of faraway text signs which have to be recognized. The consecutive frames typically capture sub-pixel information as the translation into the world sub-pixel. This provides the opportunity to aggregate information from consecutive frames to improve resolution of the text, which is also referred to as super resolution. The same spatio-temporal transformer construction can be leveraged with a super-resolution module. This can be implemented as a separate super-resolution block which makes use of distance from the motor vehicle 1 and inputs scale changes of the text patch into the super-resolution module.

FIG. 3 shows a further schematic block diagram according to an embodiment of the assistance system 2 or the electronic computing device 4, respectively. In the following it is in particular shown that also an image sequence 23 of a plurality of images 9 can be used. These in turn can then be supplied to a sharing of weights 24. Via a summing unit 33, in particular configured from different encoding devices 25, then in turn a concatenation 27 may take place. The concatenation 27 in turn results in a feature fusion 28. This may in particular be performed recurrent in an iteration 29 and then for example in turn be supplied to a decoder 30.

When deploying the proposed method according to FIG. 3 in particular the input of a video sequence, in particular thus a plurality of consecutive images 9, is shown. In particular in this connection it may occur that for instance also in a video sequence a sign text might be too small to be recognized, although this has been captured at least as text. In particular this may be due to the fact that the text is still far away. It may therefore equally be possible that in the present method the generation of text may be conditioned based on the detected area of the box, which was captured, wherein a certain threshold value is to be observed. Following detection of the proper area with the sign, a simple object tracking algorithm, such as for instance a Kalman filter, may be employed to track the sign.

1. A method for detecting and recognizing a street sign in an environment of a motor vehicle by an assistance system of the motor vehicle, the method comprising:
capturing at least one image of the environment by an optical capturing device of the assistance system;
encoding the captured image by a transformer device of an electronic computing device of the assistance system;
first decoding of the encoded image by a detection transformer device of the electronic computing device for decoding object features in the captured image;
second decoding of the encoded image, wherein the second decoding is performed in parallel to the first decoding, by a recognition transformer device of the electronic computing device for text recognition in the captured image; and
detecting and recognizing of the street sign depending on the decoded object features and the text recognition by the electronic computing device.

2. The method according to claim 1, wherein the transformer device is provided as convolutional neural network.

3. The method according to claim 1, wherein the transformer device comprising a self-attention module is provided.

4. The method according to claim 1, wherein the detection transformer device comprising a further self-attention module is provided.

5. The method according to claim 1, wherein by the detection transformer device a multiple object detection is performed.

6. The method according to claim 1, wherein by a Hungarian method and/or a bipartite loss method a joining of the object detection and the text recognition is performed by the electronic computing device.

7. The method according to claim 1, wherein the recognition transformer device comprising a yet further self-attention module is provided.

8. The method according to claim 1, wherein the recognition transformer device comprising a vocabulary database is provided.

9. The method according to claim 1, wherein the text recognition is performed in a word-based or character-based manner.

10. The method according to claim 1, wherein for text recognition a softmax function of the recognition transformer device is used.

11. The method according to claim 1, wherein based on the detection and recognition of the street sign an update of an environment map and/or a localization of the motor vehicle (1) relative to the environment is performed.

12. The method according to claim 1, wherein for the detection and recognition of the street sign a current speed of the motor vehicle is considered and/or a resolution improvement of the at least one image is performed.

13. A computer program product comprising program code means, which, when the program code means are executed by an electronic computing device, cause the electronic computing device to perform a method according to claim 1.

14. A computer-readable storage medium comprising a computer program product according to claim 13.

15. An assistance system for a motor vehicle for detecting and recognizing a street sign in an environment of the motor vehicle, comprising at least one optical capturing device and an electronic computing device, wherein the assistance system is configured for performing a method according to claim 1.
